(19) United States
(12) Patent Application Publication
(10) Pub. No.: US 2022/0138193 A1
(43) Pub. Date: May 5, 2022

(54) CONVERSION METHOD AND SYSTEMS FROM NATURAL LANGUAGE TO STRUCTURED QUERY LANGUAGE

(71) Applicant: ORIENTAL MIND (WUHAN) COMPUTING TECHNOLOGY CO., LTD., Wuhan (CN)

(72) Inventors: CHI XU, Wuhan (CN); Mingyu LUO, Wuhan (CN); Jian LIN, Wuhan (CN)

(21) Appl. No.: 17/574,582

(22) Filed: Jan. 13, 2022

Related U.S. Application Data
(63) Continuation of application No. PCT/CN2020/118904, filed on Sep. 29, 2020.

(30) Foreign Application Priority Data
Jun. 2, 2020 (CN) 2020104913071

(51) Int. Cl. G06F 16/2452; G06F 40/40

(52) U.S. Cl. CPC G06F 16/24522; G06F 40/40

(57) ABSTRACT

The present application discloses a conversion method and system from natural language to structured query language. The method includes obtaining a natural language question text; converting from the natural language question text to the structured query language according to similarities between the natural language question text and natural language questions in a preset dataset; and when there is no target natural language question in the preset dataset, converting the natural language question text to the structured query language by a conversion algorithm model.

### CROSS-REFERENCE TO RELATED APPLICATIONS

This present application is a continuation-application of International (PCT) Patent Application No. PCT/CN2020/118904, filed on 2020Sep., 29, which claims foreign priorities of Chinese Patent Application No. 202010491307.1, filed on 2020Jun. 2, the entire contents of which are hereby incorporated by reference.

### TECHNICAL FIELD

The present application relates to a technical field of data processing, and in particular to a conversion method and systems from natural language to structured query language.

### BACKGROUND

With rapid development of a deep learning industry in recent years, the deep learning industry has not only made impressive progress in areas of computer vision, phonetic recognition and autopilot, but also made substantial development in Natural Language Processing (NLP). The performance of neural network models in deep learning in tasks, such as named entity recognition, part-of-speed tagging, sentiment analysis, reading comprehension, and machine translation in the field of natural language processing has completely surpassed traditional methods.

In today's rapid development of information technology, a large amount of data in generated every day and stored in various databases. Generally, query data in a database requires interaction with a programmatic query language such as Structured Query Language (SQL). However, for many non-professionals, there is a certain technical threshold to master the SQL language. In order to allow non-professional users to query the database on demand, it has become an emerging research hotspot how to query the target data in the data base through the natural language.

Most of the existing similar work is based on traditional language rules or template matching methods, and the generalization and flexibility of algorithms have certain limitations.

### SUMMARY

Embodiments of the present application disclose a conversion method and systems from natural language to structured query language, which can lower the access threshold of the structured database, and facilitate non-technical personnel to directly query and use the structured database.

In a first aspect, embodiments of the present application provide a conversion method from natural language to structured query language. The method includes:

obtaining a natural language question text input by a user;

determining a conversion result from the natural language question text to the structured query language according to similarities between the natural language question text and natural language questions in a preset dataset, wherein the preset dataset comprises the natural language questions and corresponding structured query languages; and

when there is no target natural language question in the preset dataset, convert the natural language question text to the structured query language by a conversion algorithm model, wherein the target natural language question is one of the natural language questions with a highest similarity to the natural language question text in the preset dataset, and the similarity of the natural language question text and the target natural language question is greater than a similarity threshold, the conversion algorithm model is obtained by performing a model training based on a deep learning algorithm model.

In a second aspect, embodiments of the present application provide a conversion system from natural language to structured query language. The conversion system from natural language to structured query language includes all or a part of the functional modules, which implements first aspect or are in the method described in any one of the possible implementations of the first aspect.

In a third aspect, embodiments of the present application provide a conversion system from natural language to structured query language. The conversion system from natural language to structured query language includes at least one processor, a communication interface and a storage. The communication interface, the storage and the at least one processor are interconnected by wires, and a computer program is stored in the-storage; when the computer program is executed by the processor, the first aspect or the method described in any one of the possible implementations of the first aspect is implemented.

In a fourth aspect, embodiments of the present application provide a computer-readable storage medium, and a computer program is stored in the computer-readable storage medium; when the computer program runs through a processor, the method described in the first aspect or any one of the possible implementations of the first aspect is implemented,

By implementing the embodiments of the present application, the access threshold of the structured database can be lowered, and it is convenient for non-technical personnel to directly query and use structured databases. Compared with traditional algorithms based on language rules or template matching, algorithms based on deep learning have more advantages in flexibility and generalization.

### BRIEF DESCRIPTION OF THE DRAWINGS

In order to explain the embodiments of the present application or technical solutions in prior art more clearly, the following will briefly introduce the drawings that need to be used in the embodiments of the present application or the background technology.

FIG. 1 is a schematic flowchart of a conversion method from natural language to structured query language provided by an embodiment of the present application.

FIG. 2 is a schematic flowchart of another conversion method from natural language to structured query language provided by an embodiment of the present application.

FIG. 3 is a schematic structural diagram of a text similarity model provided by an embodiment of the application.

FIG. 4 is a schematic flowchart of another conversion method from natural language to structured query language provided by an embodiment of the present application.

FIG. 5 is a schematic structural diagram of a deep learning algorithm model provided by an embodiment of the application.

FIG. 6 is a schematic structural diagram of another text similarity model provided by an embodiment of the application.

FIG. 7 is a schematic structural diagram of another deep learning algorithm model provided by an embodiment of the application.

FIG. 8 is a structural schematic diagram of a conversion system from natural language to structured query language provided by an embodiment of the present application.

FIG. 9 is a structural schematic diagram of another conversion system from natural language to structured query language provided by an embodiment of the present application.

### DETAILED DESCRIPTION

The technical solution in the embodiments of the present application will be described in conjunction with the drawings.

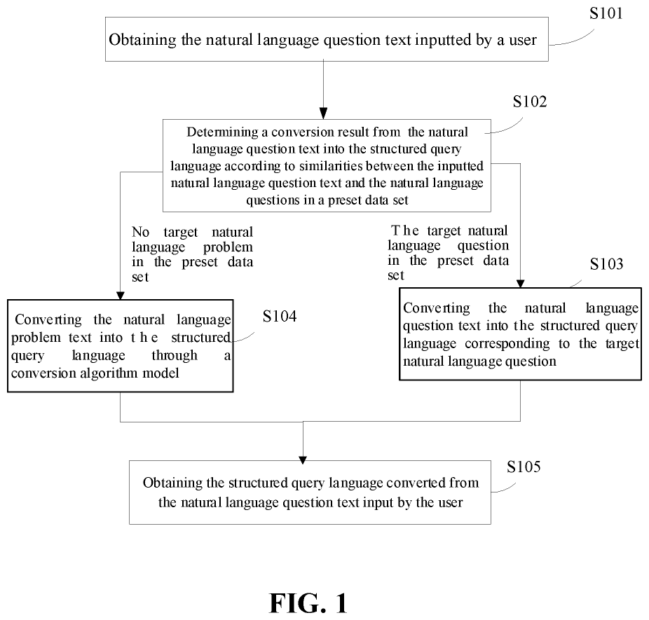

Referring to FIG. 1, FIG.1 shows a conversion method from natural language to structured query language provided by an embodiment of the present application. The method can be run on a certain computer, such as smart phones, laptops, servers, etc. The method can include, but is not limited to following steps:

Step S101: obtaining a natural language question text input by a user.

Specifically, the natural language question text is a natural language question for querying the content of a specific database.

Step S102: determining a conversion result from the natural language question text into the structured query language according to similarities between the natural language question text and the natural language questions in a preset dataset.

Specifically, the preset dataset includes the structured query languages corresponding to the natural language questions. In this embodiment of the present application, the system can use a text similarity model algorithm to obtain the similarities between the natural language question text and the natural language questions in the preset dataset, so as to convert the natural language question text to the structured query language. And using the text similarity model algorithm to obtain the similarities between texts can be achieved through the following steps.

First, it is extracted through the text similarity model that the feature vector of the natural language question text and the feature vectors of the natural language questions in the preset dataset.

Specifically, the natural language question text is processed by using the similarity model to obtain the vector value of the natural language question text embedded in the high-dimensional vector space, namely the feature vector of the natural language question text. And by embedding the natural language question text and the natural language questions in the preset dataset into a high-dimensional vector space, the feature vector of the natural language question text and feature vectors of the natural language questions in the preset dataset can be obtained.

Then, it is calculated through the text similarity model that distances between the feature vector of the natural language question text and the feature vectors of the natural language questions in the preset dataset, and the distances are as the feature vectors configured for calculating the similarities between the natural language question text and the natural language questions in the preset dataset.

Specifically, it is calculated by the text similarity model that the distances between the feature vector of the natural language question text and the feature vectors of any natural language questions in the preset dataset, it obtains the similarities between the natural language question text and any of the natural language questions, and the similarity values indicate the degrees of the similarities between the natural language question text and the natural language questions in the preset dataset.

Finally, it is determined a magnitude relationship between the similarity threshold and the similarities between the natural language question text and each of the natural language questions in the preset dataset.

Specifically, the similarity threshold is a preset threshold, which is configured to determine the degrees of the similarities between the natural language question text and each of the natural language questions in the preset dataset. When a similarity value between the natural language question text and some of the natural language questions in the preset dataset is greater than the similarity threshold, it is considered that the two sentences express the same meaning. If there is a natural language question whose similarity to the natural language question text is greater than the similarity degree threshold, step S103 is executed; if there is no natural language question whose similarity to the natural language question text is greater than the similarity degree thresholds, step S104 is executed.

Step S103: when there is the target natural language question in the preset dataset, converting the natural language question text into the structured query language corresponding to the target natural language question.

Specifically, the target natural language question is one of the natural language questions in the preset dataset with a highest similarity to the natural language question text, and the similarity of the natural language question text and the target natural language question is greater than the similarity degree threshold.

Step S104: when there is no target natural language question in the preset dataset, converting the natural language question text into the structured query language through a conversion algorithm model.

Specifically, the conversion algorithm model is obtained by performing model training based on the deep learning algorithm model. There is no target natural language question in the preset dataset, namely the similarities between the natural language question text and each of the natural language questions in the preset dataset are less than a preset similarity threshold. In the embodiment of the present application, the system uses the deep learning neural network text encoding model algorithm to encode the text and perform inference calculations to obtain the converted structured query language. When the deep learning neural network text encoding algorithm model is applied to encode the text, the text content includes the natural language question text and the table column information of the above-mentioned specific database.

Step S105: obtaining the structured query language converted from the natural language question text input by the user.

Specifically, if there is a natural language question whose similarity to the natural language question text is greater than the similarity threshold, the system will use the structured query language corresponding to the target natural language question as the structured query language converted from the natural language question text input by the user; if there is no natural language question whose similarity to the natural language question text is greater than the similarity threshold, the system uses the conversion algorithm model and inputs the natural language question text into the conversion algorithm model to obtain a converted structured query language.

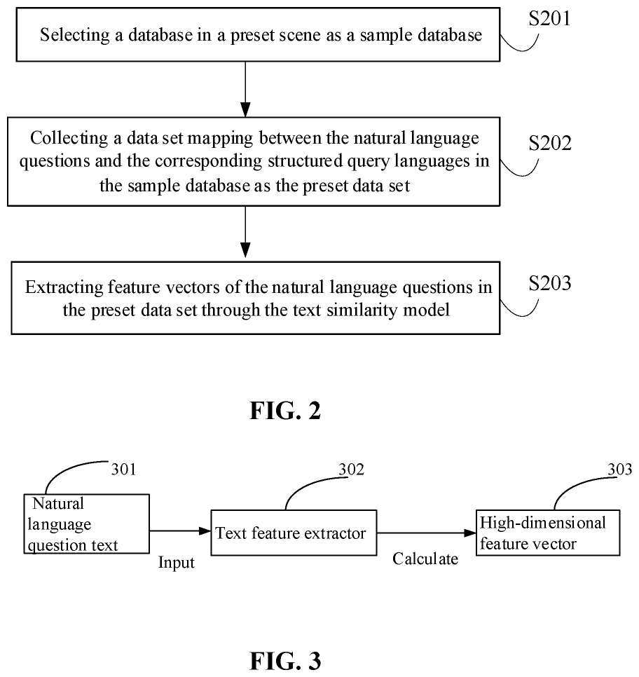

Further, referring to FIG. 2, in this embodiment, before the step S102 is performed, steps S201 to S203 may be performed.

Step S201: selecting a database in a preset scene as a sample database.

Specifically, in different business scenarios, a database corresponding to a business scenario is selected as the sample database, and the sample database includes natural language questions and corresponding structured query languages.

Step S202: collecting a dataset mapping between the natural language questions and the corresponding structured query languages in the sample database as the preset dataset.

Step S203: extracting feature vectors of the natural language questions in the preset dataset through the text similarity model.

Specifically, the feature vectors are configured to calculate the distances between the natural language question text and the natural language questions in a preset dataset, and the distances as the feature vectors are configured to calculate the similarities of the natural language question text to the natural language questions in the preset dataset. Referring to FIG. 3, which is a structural diagram of the text similarity model provided by the present application. The natural language question text in the preset dataset corresponds to the natural language question text 301 in FIG.3. Using the text feature extractor 302, the natural language question text 301 is embedded in the high-dimensional vector space to obtain a high-dimensional feature vector 303. Each natural language question text is an independent vector in the high-dimensional vector space.

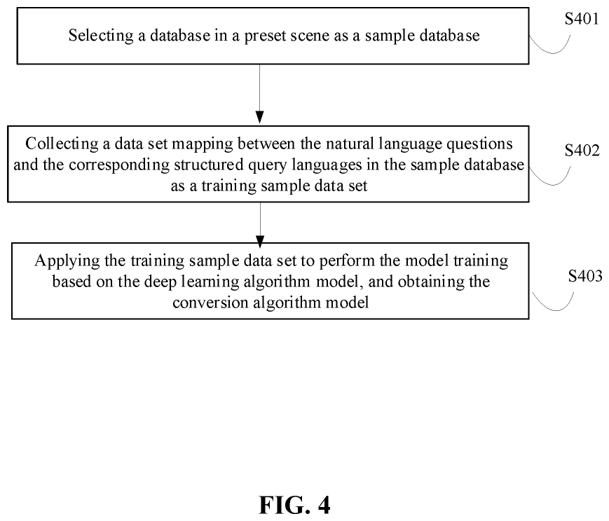

Further, referring to FIG. 4, in this embodiment, before the step S104 is performed, steps S401 to S403 may be performed.

Step S401: selecting a database in a preset scene as a sample database.

Specifically, in different business scenarios, a database corresponding to a business scenario is selected as the sample database, and the sample database includes natural language questions and corresponding structured query languages.

Step S402: collecting a data set mapping between the natural language questions and the corresponding structured query languages in the sample database as a training sample dataset.

Specifically, for the sample database, the natural language questions and the corresponding structured query languages are collected, and the collected natural language questions and corresponding structured query languages are mapped in a one-to-one correspondence as the training sample dataset.

Step S403: applying the training sample dataset to perform a model training based on the deep learning algorithm model, and obtaining the conversion algorithm model.

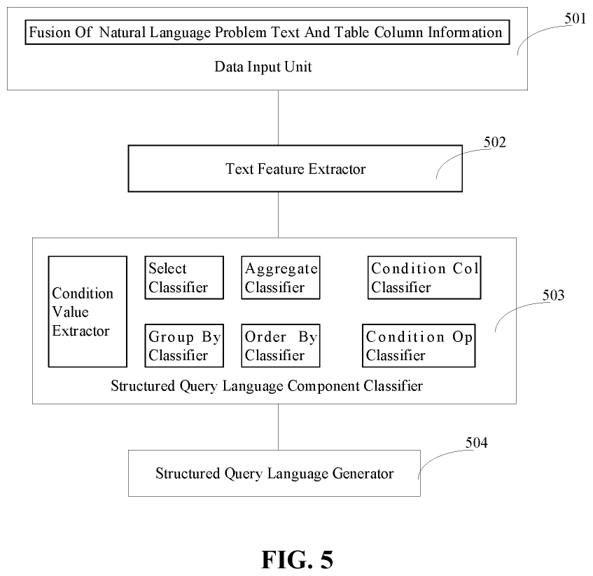

Specifically, the deep learning algorithm model is a conversion algorithm model which uses a text encoder algorithm model, during a processing of the model training, the training datasets namely the natural language questions and the corresponding structured query languages are configured as training data input, and tasks of converting to structured query languages are defined as the classification tasks of mapping the table column information of the sample database to the structured query language elements such as select, aggregate, condition col, condition op, group by, order by, etc., and a task set of extracting condition values from the natural language questions, which enabling the deep learning algorithm model to learn from a natural language to a structured query language. Please refer to FIG. 5. FIG. 5 is a structure diagram of the deep learning algorithm model provided by the present application. The structure of the deep learning algorithm model includes a data input unit 501, a text feature extractor 502, and a structured query language component classifier 503 and structured query language generator 504, each module and unit of the deep learning algorithm model is descripted in detail as follows:

The data input unit 501 is configured to fuse natural language questions and table column information of the sample database;

The text feature extractor 502 is configured to encode the text of the data input unit 501 and obtain the encoded high-dimensional vector value;

The structured query language component classifier 503 is configured to define the structured query languages as the classification tasks of mapping the high-dimensional vector input by the text feature extractor 502 to the structured query language elements such as select, aggregate, condition col, condition op, group by, order by, etc., and a task set of extracting condition values. It is separately classified with a classification algorithm that the part of each table column information represented by the high-dimensional vector output by the text feature extractor 502, and obtained results of classification tasks in select, aggregate, condition col, condition op, group by, order by, etc. listed in each table column; at same time, the value of condition value is extracted from the part representing the natural language question text in the high-dimensional vector output by the text feature extractor 502.

The structured query language generator 504 is configured to summarize the results of classification tasks, such as select, aggregate, condition col, condition op, group by, order by, and so on, obtained by the structured query language component classifier 503 and the extracted condition value to obtain a complete structured query language.

Hereinafter, the present invention will be described with a specific example in conjunction with the accompanying drawings.

Step S101: obtaining the natural language question text input by a user.

Specifically, the user is an operator who operates this system. Assuming that the current sample database is a user information table of a telecommunications carries, the operator wants to know the number of users of the telecommunications carries, and he can enter the corresponding query sentence: “I want to query the number of users in Beijing in 2019”, the text content is the natural language question text input by the user obtained in step S101.

Step S201: selecting a database in a preset scene as a sample database.

Specifically, the user information table of the above-mentioned telecommunications carries is configured as a sample database.

Step S202: collecting a data set mapping for natural language questions in the sample database and a corresponding structured query languages as the preset dataset.

Specifically, taking two pairs of data in the preset dataset as an example, the preset dataset includes:

Natural language question: “What is the number of users in Beijing in 2019”-structured query language: “select count(user_id) from user_info where acct_year=“2019” and city=“Beijing””;

Natural language question: “What is the total revenue of users in Beijing in 2019”-structured query language: “select sum(total fee) from user_info where acct_year=“2019” and city=“beijing””.

Step S203: extracting the feature vector of the natural language question in the preset dataset through the text similarity model.

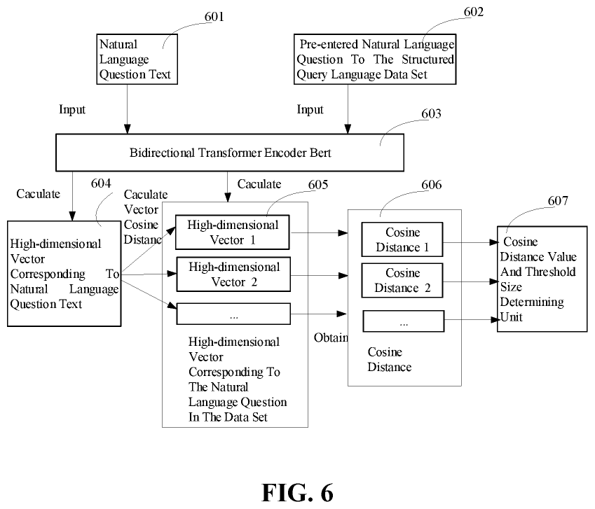

Specifically, referring to FIG. 6. FIG. 6 is a structure diagram of the text similarity model provided by the present application. The natural language question text is a natural language question text 601, and a bidirectional transformer encoder Bert 603 is configured to encode the natural language question text “I want to query the number of users in Beijing in 2019” to obtain the high-dimensional vector 604 corresponding to the natural language question text; the preset dataset is a natural language question to the structured query language data set 602, and at the same time, the natural language questions in the pre-entered natural language question to the structured query language dataset 602 are also encoded in the same way to obtain the high-dimensional vector 605 corresponding to the natural language question in the dataset; cosine distances 606 are calculated between the high-dimensional vector 604 corresponding to the natural language question text and the high-dimensional vectors 605 corresponding to the natural language questions in the dataset. The cosine distances 606 are namely the similarity values and is (0.95, 0.21) respectively.

Step 204: determining whether the similarity value is greater than the similarity threshold.

Specifically, the text similarity model determines whether the similarity value is greater than the similarity threshold through a cosine distance value and the threshold size determining unit 607. Assuming the similarity threshold is 0.9, since 0.95>0.9, in the value of the above cosine distance 606 (0.95, 0.21), the natural language question text 601 “I want to query the number of users in Beijing in 2019” has the same meaning as “What is the number of users in Beijing in 2019” in the pre-entered natural language question to the structured query language dataset 602, that is, there is the target natural language question in the pre-entered natural language question to the structured query language dataset 602, and the target natural language question is “What is the number of users in Beijing in 2019”.

Since there is the target natural language question in the pre-entered natural language question to the structured query language dataset 602, Step S103 is executed; if there is a target natural language question in the preset dataset, converting the natural language question text into a structured query language corresponding to the target natural language question.

Specifically, the structured query language “select count (user_id) from user_info where acct_year=“2019” and city=“Beijing”” corresponding to the natural language question “what is the number of users in Beijing in 2019” in the pre-entered natural language question to the structured query language dataset 602, which is used as a structured query language “I want to query the number of users in Beijing in 2019” after conversion.

Assuming that the query sentence entered by the operator is “I want to query the number of new users in Beijing in 2019”, using the text similarity model described above, a cosine distance 606 is calculated between the natural language question text 601 and the pre-entered natural language question to the structure query language dataset 602 and the cosine distance 606 is (0.72, 0.14) respectively. These two values are both smaller than the similarity threshold 0.9, indicating that there is no similar natural language question in the pre-entered natural language question to the structured query language dataset 602, that is, there is no target natural language question in the pre-entered natural language question to the structured query language dataset 602.

Since there is no target natural language question in the pre-entered natural language question to the structured query language dataset 602, step S104 is executed; if there is no target natural language question in the preset dataset, converting the natural language question text into a structured query language through the conversion algorithm model.

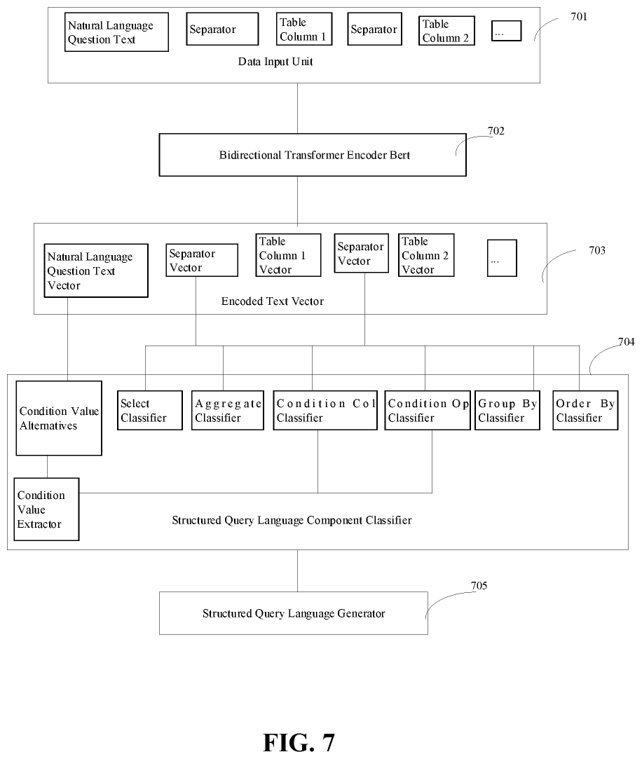

Specifically, referring to FIG. 7. FIG. 7 is a structure diagram of a deep learning algorithm model provided by the present application. The deep learning algorithm model includes a data input unit 701, a bidirectional Transformer encoder Bert 702, a structured query language component classifier 704, and a structured query language generator 705. A detail description of each model and unit of the deep learning algorithm model is as follows:

The data input unit 701 is configured to merge the natural language question text “I want to query the number of new users in Beijing in 2019” and information of the multiple table column names in the sample database, and use a separator to separate.

The bidirectional transformer encoder Bert 702 is configured to encode the text of the data input unit 701.

Specifically, the encoded high-dimensional vector obtained by the bidirectional Transformer encoder Bert 702 is an encoded text vector 703. The encoded text vector 703 includes a natural language question text vector, multiple table column vectors and corresponding separator vector.

The structured query language component classifier 704 is configured to define the structured query language as the classification tasks of mapping the high-dimensional vectors output from the encoded text vector 703 to the structured query language elements such as select, aggregate, condition col, condition op, group by, order by, etc., and a task set of extracting condition values from the natural language questions.

Specifically, the structured query language component classifier 704 is configured to respectively connect the separator vectors representing each table column information in the high-dimensional vector output by the bidirectional transformer encoder Bert702 to the select classifier (output whether the current column is selected), aggregate classifier (output an aggregate operator of the current column), condition col classifier (output whether the current column belongs to the condition column), condition op classifier (the output condition operator of the current column), group by classifier (output whether the current column is grouped by), order by classifier (output whether the current column is ordered by), to classify using the classification algorithm, and to get results of classification tasks in select, aggregate, condition col, condition op, group by, order by, etc. listed in each table.

For the condition value task, several candidate condition values are extracted using a text extraction algorithm (the initial index of the output value is two values) from a part of the high-dimensional vector output by the bidirectional Transformer encoder Bert702 that represents the natural language question text, and then merge the permutation and combination with the classification results of condition col and condition op, and use the classification algorithm (output whether the current candidate value is the final result) to obtain the final condition value.

The structured query language generator 705 is configured to summarize the results of classification tasks such as select, aggregate, condition col, condition op, group by, order by obtained in the structured query language component classifier 704 and the extracted condition value, and to obtain a complete structured query language.

Specifically, taking the natural language question text “I want to query the number of new users in Beijing in 2019” as an example, the steps performed by the deep learning algorithm model are as follows:

First, the natural language question text “I want to query the number of new users in Beijing in 2019” and the table column information of the sample database are input into the data input unit 701 for combination.

Second, the encoded text vector 703 is obtained through the bidirectional transformer encoder Bert 702.

Third, the encoded text vector 703 is input into the structured query language component classifier 704, wherein, for the select classifier, the output result of the column user_id is true, and the output results of the other columns are false; for the aggregate classifier, the output result of the column user_id is count, and the output results of the other columns are non; for the condition col classifier, the output results of the columns acct_year, user_states, and city are true, and the output results of the other columns are false; for the condition op classifier, the values of the columns acct_year, user_states, and city are all “=”, and the values of the other columns are all non; for group by and order by classifier, all column values are non. For the condition value task, the candidate condition values are extracted from part of the natural language question text in the encoded text vector, including “Beijing”, “2019”, and “new”, and then combined with the results of the above condition col (acct_year, user_states, city) and the results of condition op (=, =, =) to perform the fusion of permutation and combination, that is, a condition value extractor is used to judge respectively which of the output results is true that (acct_year=“2019”, acct_year=“new”, acct_year=“Beijing), (user_states=“2019”, user_states=“new”, user states=“Beijing”), (city=“2019”, city=“new”, city=“Beijing”), here it is judged that acct_year=“2019” is true, user_states=“new” is true, and city=“Beijing” is true.

Fourth. the structured query language generator 705 is used to combine the results output by the structured query language component classifier 704 to obtain the structured query language “select count(user_id) from user_info where acct_year=“2019” and user_states=“new” and city=“Beijing”” corresponding to the query sentence “I want to query the number of new users in Beijing in 2019” input by the operator.

In the embodiments of the present application, before step S104 is performed, steps S401 to S403 are also performed to train the deep learning algorithm model.

Step S401: selecting a database in a preset scene as a sample database.

Specifically, the user information table of the telecom operator is selected as the sample database.

Step S402: collecting a data set mapping for a natural language question in the sample database and a corresponding structured query language as a training sample dataset.

Specifically, for the training sample dataset, the larger the number of the data is better. Here, only two pairs of data of the training sample data set are taken as an example, the training sample dataset includes:

Natural language question: “what is the number of users in Beijing in 2019”-structured query language: select count(user_id) from user_info where acct_year=“2019” and city=“Beijing””;

Natural language question: “what is the total income of users in Beijing in 2019”-structured query language: “select sum(total_fee) from user_info where acct_year=“2019” and city=“Beijing””.

Step S403: based on the deep learning algorithm model, applying the training sample dataset to perform model training, and obtaining the conversion algorithm model.

Specifically, the natural language question in the training sample dataset and the table structure information of the sample database are spliced as input, and the corresponding structured query language is used as the output, the deep learning algorithm model is established, and the model training is performed to obtain natural language to structured query language conversion algorithm model. Wherein, the deep learning algorithm model uses the bidirectional transformer encoder model (BERT) to encode the input data; defines the output structured query language as the classification tasks of the structured query language elements such as select, aggregate, condition col, condition op, group by, order by, etc. and extracts the task set of the condition value from the natural language question. Which enabled the deep learning algorithm model to learn a conversion algorithm model from a natural language question to a structured query language.

In the above method, the access threshold of the structured database can be lower, and it is convenient for non-technical personnel to directly query and use the structured database. Compared with the traditional algorithm based on language rules or template match, the flexibility and generalization of the algorithm based on the deep learning.

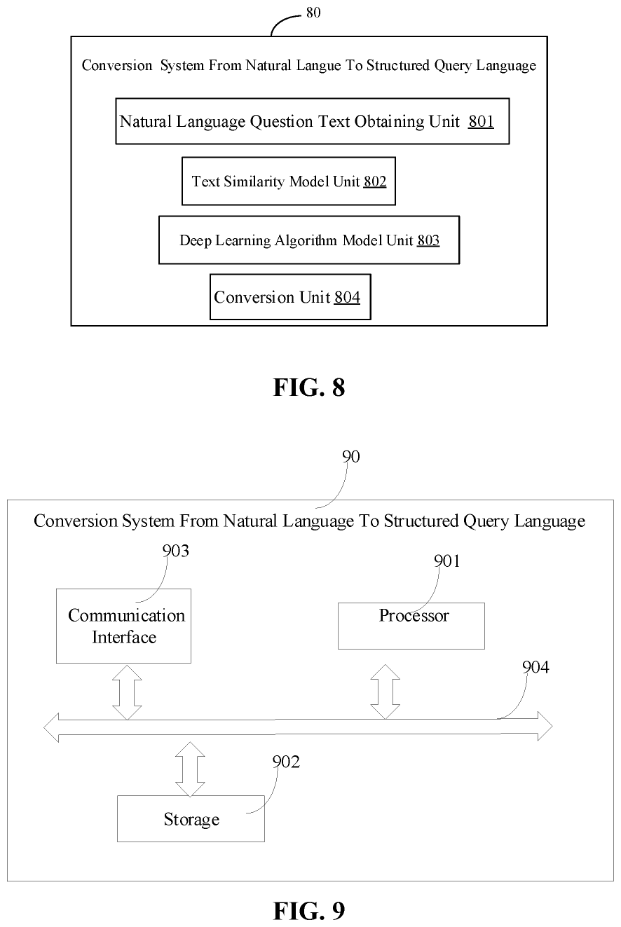

Referring to FIG. 8, FIG.8 is a conversion system 80 from natural language to structured query language provided by the present application. The conversion system 80 from natural language to structured query language includes a natural language question text obtaining unit 801, a text similarity model unit 802, and a deep learning algorithm model unit 803. A detail description of each model and unit of the conversion system 80 from natural language to structured query language is as follows.

The natural language question text obtaining unit 801, is configured for obtaining a natural language question text input by a user.

The text similarity model unit 802, is configured for determining a conversion result from the natural language question text to the structured query language according to similarities between the natural language question text and natural language questions in a preset dataset, wherein the preset dataset includes the natural language questions and the corresponding structured query languages.

The deep learning algorithm model unit 803, is configured for converting the natural language question text to the structured query language by a conversion algorithm model when there is no target natural language question in the preset dataset, wherein the target natural language question is one of the natural language questions with a highest similarity to the natural language question text in the preset dataset, and the similarity of the natural language question text and the target natural language question is greater than a similarity threshold, the conversion algorithm model is obtained by performing model training based on a deep learning algorithm model.

In an alternative solution, the text similarity model unit 802, after determining the conversion result from the natural language question text to the structured query language according to the similarities between the natural language question text and natural language questions in a preset dataset, is further configured for converting the natural language question text to the structured query language corresponding to the target natural language question when there is a target natural language question in the preset dataset.

In an alternative solution, the text similarity model unit 802, before determining the conversion result from the natural language question text to the structured query language according to similarities between the natural language question text and natural language questions in a preset dataset, is further configured for selecting a database in a preset scene as a sample database, wherein the sample database includes the natural language questions and corresponding structured query languages; collecting a dataset mapping between the natural language questions and the corresponding structured query languages in the sample database as the preset dataset; and extracting feature vectors of the natural language questions in the preset dataset through a text similarity model, the feature vectors being configured to calculate distances between the natural language question text and the natural language questions in the preset dataset, and the distances being as the feature vectors configured to calculate the similarities of the natural language question text to the natural language questions in the preset dataset.

In an alternative solution, the text similarity model unit 802, before the determining the conversion result from the natural language question text to the structured query languages according to similarities between the natural language question text and natural language questions in the preset dataset, is further configured for extracting feature vector of the natural language question text and feature vectors of the natural language questions in the preset dataset through a text similarity model; calculating distances between the feature vector of the natural language question text and the feature vectors of the natural language questions in the preset dataset through the text similarity model, and the distances being as the feature vectors configured for calculating the similarities between the natural language question text and the natural language questions in the preset dataset.

In an alternative solution, the deep learning algorithm model unit 803, before there is no target natural language question in the preset dataset, converting the natural language question text into the structured query language by the conversion algorithm model, is further configured for selecting a database in a preset scene as a sample database, wherein the sample database comprises the natural language questions and corresponding structured query languages; collecting a dataset mapping between the natural language questions and the corresponding structured query languages in the sample database as a training sample dataset; applying the training sample dataset to perform model training based on the deep learning algorithm model; and obtaining the conversion algorithm model.

In an alternative solution, the deep learning algorithm model is a text encoder algorithm model, during a processing of the model training, the training sample datasets is configured as training data input, and a tasks of converting to the structured query languages are defined as classification tasks of mapping table column information of the sample database to structured query language elements and a task set of extracting condition values from the natural language questions.

In an alternative solution, further comprising an information conversion unit 804. The information conversion unit 804 is configured for obtaining the structured query language converted from the natural language question text input by the user after the determining the conversion result from the natural language question text to the structured query language according to the similarities between the natural language question text and the natural language questions in a preset dataset.

The specific implementation and beneficial effects of each module and unit in the conversion system from natural language to structured query language shown in FIG. 8 can also be referred to the corresponding description of the above method embodiment, which will not be repeated here.

Referring to FIG. 9, FIG. 9 is a conversion system 90 from natural language to structured query language provided by the present application. The conversion system 90 from natural language to structured query language includes a processor 901, a storage 902 and a commination interface 903. The processor 901 and the storage 902 interconnects by bus 904.

The storage 902 includes, but is not limited to a random access memory (RAM), a read-only memory (ROM), an erasable programmable read only memory (EPROM), or a compact disc read-only memory (CD-ROM). The storage 902 stores a related computer program and data. The commination interface 903 is configured for receiving and sending data.

The processor 901 can be one or more central processing units (CPU). In the case where the processor 901 is one CPU, the CPU may be a signal-core CPU or a multi-core CPU.

The processor 901 of the conversion system 90 from natural language to structured query language is configured for reading the computer program stored in the storage 902, and executing steps following:

obtaining a natural language question text input by a user;

determining a conversion result from the natural language question text to the structured query language according to similarities between the natural language question text and natural language questions in a preset dataset, wherein the preset dataset comprises the natural language questions and corresponding structured query languages; and

when there is no target natural language question in the preset dataset, converting the natural language question text to the structured query language by a conversion algorithm model, wherein the target natural language question is one of the natural language questions with a highest similarity to the natural language question text in the preset dataset, and the similarity of the natural language question text and the target natural language question is greater than a similarity threshold, the conversion algorithm model is obtained by performing model training based on a deep learning algorithm model.

In an alternative solution, after determining the conversion result from the natural language question text to the structured query language according to the similarities between the natural language question text and the natural language questions in the preset dataset, further executing:

converting the natural language question text to the structured query language corresponding to the target natural language question when there is a target natural language question in the preset dataset.

In an alternative embodiment, before determining the conversion result from the natural language question text to the structured query language according to the similarities between the natural language question text and the natural language questions in a preset dataset, further executing:

selecting a database in a preset scene as a sample database, wherein the sample database comprises the natural language questions and the corresponding structured query languages;

collecting a dataset mapping between the natural language questions and the corresponding structured query languages in the sample database as the preset dataset;

extracting feature vectors of the natural language questions in the preset dataset through a text similarity model, the feature vectors being configured to calculate distances between the natural language question text and the natural language questions in the preset dataset, and the distances being as the feature vectors configured to calculate the similarities of the natural language question text to the natural language questions in the preset dataset.

In an alternative embodiment, before determining the conversion result from the natural language question text to the structured query languages according to the similarities between the natural language question text and natural language questions in a preset dataset, further executing:

extracting a feature vector of the natural language question text and feature vectors of the natural language questions in the preset dataset through a text similarity model;

calculating distances between the feature vector of the natural language question text and the feature vectors of the natural language question in the preset dataset through the text similarity model, and the distances being as the feature vectors configured for calculating the similarities between the natural language question text and the natural language questions in the preset dataset.

In an alternative embodiment, before there is no target natural language question in the preset dataset, converting the natural language question text into the structured query language by the conversion algorithm model, further executing:

selecting a database in a preset scene as a sample database, wherein the sample database comprises the natural language questions and the corresponding structured query languages;

collecting a dataset mapping between the natural language questions and the corresponding structured query languages in the sample database as a training sample dataset;

applying the training sample dataset to perform model training based on the deep learning algorithm model; and obtaining the conversion algorithm model.

In an alternative embodiment, the deep learning algorithm model is a text encoder algorithm model, during a processing of the model training, the training sample datasets are configured as training data input, and tasks of converting to the structured query languages are defined as classification tasks of mapping table column information of the sample database to structured query language elements and a task set of extracting condition values from the natural language questions.

In an alternative embodiment, after the determining the conversion result from the natural language question text to the structured query language according to the similarities between the natural language question text and the natural language questions in the preset dataset, further executing:

obtaining the structured query language converted from the natural language question text input by the user.

The specific implementation and beneficial effects of each module and unit in the conversion system from natural language to structured query language shown in FIG. 9 can also be referred to the corresponding description of the above method embodiment, which will not be repeated here.

The embodiments of the present application provides a computer-readable storage medium. The computer-readable storage medium stores a computer program. When the computer program runs on the conversion system from natural language to structured query language to complete the above mentioned method.

To sum up, the access threshold of the structured database can be lowered, and it is convenient for non-technical personnel to directly query and use structured databases. Compared with traditional algorithms based on language rules or template matching, algorithms based on deep learning have more advantages in flexibility and generalization.

What is claimed is:

1. A conversion method from natural language to structured query language, comprising:
obtaining a natural language question text input by a user;
determining a conversion result from the natural language question text to the structured query language according to similarities between the natural language question text and natural language questions in a preset data set, wherein the preset dataset comprises the natural language questions and corresponding structured query languages; and
when there is no target natural language question in the preset dataset, converting the natural language question text to the structured query language by a conversion algorithm model, wherein the target natural language question is one of the natural language questions with a highest similarity to the natural language question text in the preset dataset, and the similarity of the natural language question text and the target natural language question is greater than a similarity threshold, the conversion algorithm model is obtained by performing a model training based on a deep learning algorithm model.

2. The conversion method according to claim 1, wherein after determining the conversion result from the natural language question text to the structured query language according to the similarities between the natural language question text and the natural language questions in the preset dataset, the conversion method further comprises:
when there is the target natural language question in the preset dataset , converting the natural language question text to the structured query language corresponding to the target natural language question.

3. The conversion method according to claim 1, wherein before determining the conversion result from the natural language question text to the structured query language according to the similarities between the natural language question text and the natural language questions in a preset dataset, the conversion method further comprising:
selecting a database in a preset scene as a sample database, wherein the sample database comprises the natural language questions and the corresponding structured query languages;
collecting a data set mapping between the natural language questions and the corresponding structured query languages in the sample database as the preset dataset;
extracting feature vectors of the natural language questions in the preset dataset through a text similarity model, wherein, the feature vectors are configured to calculate distances between the natural language question text and the natural language questions in the preset dataset, and the distances are as the feature vectors configured to calculate the similarities of the natural language question text to the natural language questions in the preset dataset.

4. The conversion method according to claim 1, wherein before determining the conversion result from the natural language question text to the structured query language according to the similarities between the natural language question text and the natural language questions in a preset dataset, the conversion method further comprising:
extracting a feature vector of the natural language question text and the feature vectors of the natural language questions in the preset dataset through a text similarity model;
calculating distances between the feature vector of the natural language question text and the feature vectors of the natural language questions in the preset dataset through the text similarity model, and the distances being as the feature vectors configured for calculating the similarities between the natural language question text and the natural language questions in the preset dataset.

5. The conversion method according to claim 1, wherein before there is no target natural language question in the preset dataset, converting the natural language question text into the structured query language by the conversion algorithm model, the conversion method further comprising:
selecting a database in a preset scene as a sample database, wherein the sample database comprises the natural language questions and the corresponding structured query languages;
collecting a dataset mapping between the natural language questions and the corresponding structured query languages in the sample database as a training sample dataset;
applying the training sample data set to perform the model training based on the deep learning algorithm model; and obtaining the conversion algorithm model.

6. The conversion method according to claim 5, wherein the deep learning algorithm model is a text encoder algorithm model, during a processing of the model training, the training sample dataset is configured as training data input, and tasks of converting to the structured query languages are defined as classification tasks of mapping table column information of the sample database to structured query language elements and a task set of extracting condition values from the natural language questions.

7. The conversion method according to claim 1, wherein after determining the conversion result from the natural language question text to the structured query language according to the similarities between the natural language question text and the natural language questions in the preset dataset, the conversion method further comprising:
obtaining the structured query language converted from the natural language question text input by the user.

8. A conversion system from natural language to structured query language, comprising
a natural language question text obtaining unit, configured for obtaining a natural language question text input by a user;
a text similarity model unit, configured for determining a conversion result from the natural language question text to the structured query language according to similarities between the natural language question text and natural language questions in a preset dataset, wherein the preset data set comprises the natural language questions and corresponding structured query languages; and
a deep learning algorithm model unit, configured for converting the natural language question text to the structured query language by a conversion algorithm model when there is no target natural language question in the preset dataset, wherein the target natural language question is one of the natural language questions with a highest similarity to the natural language question text in the preset dataset, and the similarity of the natural language question text and the target natural language question is greater than a similarity threshold, the conversion algorithm model is obtained by performing a model training based on a deep learning algorithm model.

9. The conversion system according to claim 8, wherein the text similarity model unit, after determining the conversion result from the natural language question text to the structured query language according to the similarities between the natural language question text and the natural language questions in the preset dataset, is further configured for:
converting the natural language question text to the structured query language corresponding to the target natural language question when there is the target natural language question in the preset dataset.

10. The conversion system according to claim 8, wherein the text similarity model unit, before determining the conversion result from the natural language question text to the structured query language according to the similarities between the natural language question text and the natural language questions in the preset dataset, is further configured for:
selecting a database in a preset scene as a sample database, wherein the sample database comprises the natural language questions and the corresponding structured query languages;
collecting a dataset mapping between the natural language questions and the corresponding structured query languages in the sample database as the preset dataset;
extracting feature vectors of the natural language questions in the preset dataset through a text similarity model, the feature vectors being configured to calculate distances between the natural language question text and the natural language questions in the preset dataset, and the distances being as the feature vectors configured to calculate the similarities of the natural language question text to the natural language questions in the preset dataset.

11. The conversion system according to claim 8, wherein the text similarity model unit, before determining the conversion result from the natural language question text to the structured query language according to the similarities between the natural language question text and the natural language questions in a preset dataset, is further configured for:
extracting a feature vector of the natural language question text and the feature vectors of the natural language questions in the preset dataset through a text similarity model;
calculating distances between the feature vector of the natural language question text and the feature vectors of the natural language questions in the preset dataset through the text similarity model, and the distances being as the feature vectors configured for calculating the similarities between the natural language question text and the natural language questions in the preset dataset.

12. The conversion system according to claim 8, wherein the deep learning algorithm model unit, before there is no target natural language question in the preset dataset, converting the natural language question text into the structured query language by the conversion algorithm model, is further configured for:
selecting a database in a preset scene as a sample database, wherein the sample database comprises the natural language questions and the corresponding structured query languages;
collecting a dataset mapping between the natural language questions and the corresponding structured query languages in the sample database as a training sample dataset;
applying the training sample dataset to perform the model training based on the deep learning algorithm model; and obtaining the conversion algorithm model.

13. The conversion system according to claim 12, wherein the deep learning algorithm model is a text encoder algorithm model, during a processing of the model training, the training sample dataset is configured as training data input, and tasks of converting to the structured query language are defined as classification tasks of mapping table column information of the sample database to structured query language elements and a task set of extracting condition values from the natural language questions.

14. The conversion system according to claim 8, further comprising a conversion unit configured for obtaining the structured query language converted from the natural language question text input by the user.

15. A conversion system from natural language to structured query language, comprising at least one processor, a communication interface and a storage, the commination interface, the storage and the at least one processor interconnects by wires, the storage stores computer program, the computer program is executed by the at least one processor to complete the method according to claim 1.

16. A computer readable storage media, storing a computer program, the computer program runs on at least one processor to complete the method according to claim 1.
